(19) United States
(12) Patent Application Publication
(10) Pub. No.: US 2021/0325594 A1
(43) Pub. Date: Oct. 21, 2021

(54) BACKLIGHT MODULE, METHOD FOR MANUFACTURING THE SAME, AND LIQUID CRYSTAL DISPLAY DEVICE

(71) Applicant: BOE TECHNOLOGY GROUP CO., LTD., Beijing (CN)

(72) Inventors: Xianqin MENG, Beijing (CN); Wei WANG, Beijing (CN); Jifeng TAN, Beijing (CN); Xiandong MENG, Beijing (CN); Jian GAO, Beijing (CN); Fangzhou WANG, Beijing (CN); Xiaochuan CHEN, Beijing (CN); Pengxia LIANG, Beijing (CN)

(21) Appl. No.: 16/482,384

(22) PCT Filed: Jan. 2, 2019
(86) PCT No.: PCT/CN2019/070025

§ 371 Date: Jul. 31, 2019

(30) Foreign Application Priority Data
Mar. 30, 2018 (CN) 201810286488.7

(51) Int. Cl. F21V 8/00

(52) U.S. Cl. CPC G02B 6/0036; G02B 6/0055; G02B 6/0053; G02B 6/004; G02B 6/0073

(57) ABSTRACT

A backlight module, a method for manufacturing the same, and a liquid crystal display device, which realize a thin uniform backlight for liquid crystal display. The backlight module includes: a light guide plate including a light exit surface and a bottom surface opposite to the light exit surface; the bottom surface including an array of inverted pyramid grooves; and a plurality of point light sources located on a side of the light exit surface away from the bottom surface; wherein a light emitting surface of each point light source faces the light exit surface.

### RELATED APPLICATIONS

The present application is a 35 U.S.C. 371 national stage application of PCT International Application No. PCT/CN2019/070025, filed on Jan. 2, 2019, which claims the benefit of Chinese Patent Application No. 201810286488.7, filed on Mar. 30, 2018, the entire disclosures of which are incorporated herein by reference.

### TECHNICAL FIELD

The present disclosure relates to the field of display technology, and in particular, to a backlight module, a method for manufacturing the same, and a liquid crystal display device.

### BACKGROUND

Liquid crystal display (LCD) has become a mainstream product in flat panel display devices due to its small size, low power consumption, and no radiation. The backlight module of the liquid crystal display device generally includes a lateral entry type and a direct type. The thickness of the direct type backlight module is mainly determined by the height of the cavity between the reflective film and the diffusing plate. Theoretically, the greater the height of the cavity, the more uniform the light emitted from the diffusing plate. Therefore, the direct type backlight generally achieves uniform light output by increasing the thickness of the module.

### SUMMARY

The embodiments of the present disclosure provide a backlight module, a method for manufacturing the same, and a liquid crystal display device, which realize a thin uniform backlight for liquid crystal display.

According to an exemplary embodiment of the present disclosure, a backlight module is provided. The backlight module includes: a light guide plate including a light exit surface and a bottom surface opposite to the light exit surface; the bottom surface including an array of inverted pyramid grooves; and a plurality of point light sources located on a side of the light exit surface away from the bottom surface. A light emitting surface of each point light source faces the light exit surface.

In certain exemplary embodiments, the backlight module further includes a reflective layer. The reflective layer includes a fitting surface, and the fitting surface fits with the bottom surface. A shape of the fitting surface is complementary to a shape of the bottom surface.

In certain exemplary embodiments, each point light source corresponds to a cone top of an inverted pyramid groove in the array of inverted pyramid grooves.

In certain exemplary embodiments, each inverted pyramid groove is a quadrangular pyramid groove.

In certain exemplary embodiments, in the quadrangular pyramid groove, an included angle formed by a side surface of the quadrangular pyramid groove and a bottom surface of the quadrangular pyramid groove is in a range of 40°˜70°.

In certain exemplary embodiments, each point light source has a beam angle of about 120°.

In certain exemplary embodiments, each point light source is individually controlled and the plurality of point light sources have different brightness from each other.

In certain exemplary embodiments, the plurality of point light sources are light emitting diodes. For example, the point light source may be a micro-light emitting diode (Micro-LED) having a size of less than or equal to 100 μm.

In certain exemplary embodiments, the backlight module further includes a plurality of dots located on the light exit surface. The plurality of dots are configured to redirect light to a direction perpendicular to the light exit surface.

In certain exemplary embodiments, the backlight module further includes a brightness enhancement film disposed on a side of the light guide plate away from the reflective layer.

In certain exemplary embodiments, a material of the reflective layer is a reflective metal; a material of the light guide plate is one of a transparent resin material and a transparent PMMA material.

According to another exemplary embodiment of the present disclosure, a liquid crystal display device is provided. The liquid crystal display device includes a liquid crystal display panel and the backlight module according to any one of above-mentioned embodiments. The backlight module is disposed on a light entrance side of the liquid crystal display panel.

According to yet another exemplary embodiment of the present disclosure, a method for manufacturing a backlight module is provided. The method includes: providing a light guide plate, the light guide plate including a light exit surface and a bottom surface opposite to the light exit surface, the bottom surface including an array of inverted pyramid grooves; and arranging a plurality of point light sources on a side of the light exit surface away from the bottom surface, a light emitting surface of each point light source facing the light exit surface.

In certain exemplary embodiments, the step of providing the light guide plate includes: providing a light guide plate body; arranging a photoresist on a surface of the light guide plate body; performing nanoimprinting on the photoresist; and curing the photoresist.

In certain exemplary embodiments, the method further includes: providing a reflective layer. The reflective layer includes a fitting surface, and the fitting surface fits with the bottom surface; a shape of the fitting surface is complementary to a shape of the bottom surface.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 is a structural schematic diagram of a backlight module according to an embodiment of the present disclosure;

FIG. 2 is a top view of the light guide plate in the embodiment shown in FIG. 1;

FIG. 3a is a schematic diagram of an inverted pyramid structure reflecting light according to an embodiment of the present disclosure;

FIG. 3b is a far field light distribution pattern of a conventional backlight module;

FIG. 3c is a far field light distribution pattern of a backlight module according to an embodiment of the present disclosure;

FIG. 4 is a structural schematic diagram of a liquid crystal display device according to an embodiment of the present disclosure;

FIG. 5 is a schematic diagram of an electronic apparatus according to an embodiment of the present disclosure;

FIG. 6 is a flow chart of a method for manufacturing a backlight module according to an embodiment of the present disclosure; and

FIG. 7 is a process of manufacturing a light guide plate according to an embodiment of the present disclosure.

### DETAILED DESCRIPTION OF THE DISCLOSURE

In the following, the technical solutions in embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

The shapes and dimensions of the various components in the drawings do not reflect the true proportions of the components, and are merely intended to illustrate the present disclosure.

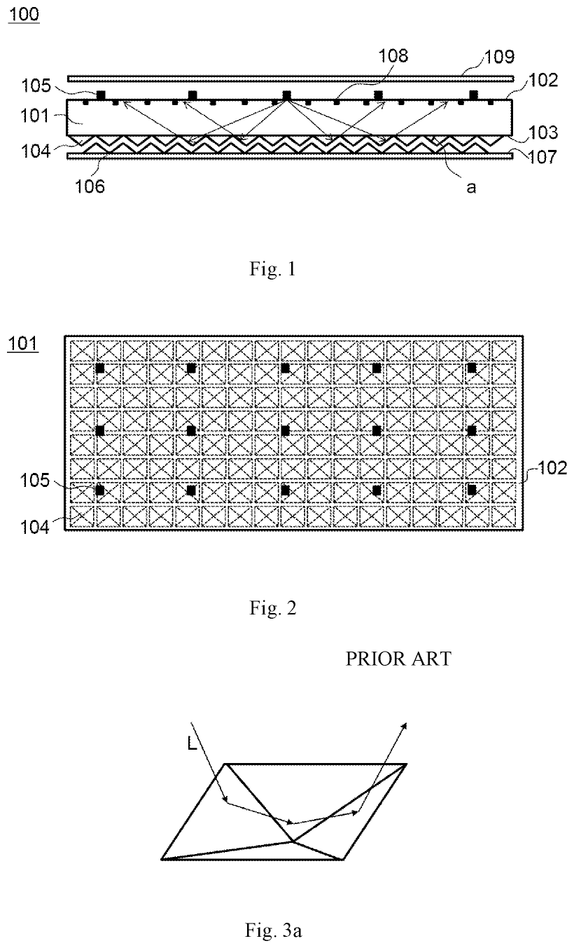

According to an exemplary embodiment of the present disclosure, a backlight module is provided. Referring to FIG. 1 and FIG. 2, the backlight module 100 includes: a light guide plate 101 including a light exit surface 102 and a bottom surface 103 opposite to the light exit surface 102; the bottom surface 103 including an array of inverted pyramid grooves 104; and a plurality of point light sources 105 located on a side of the light exit surface 102 away from the bottom surface 103. A light emitting surface of each point light source 105 faces the light exit surface 102. In the embodiment of the present disclosure, with the above arrangement, the light emitted by the point light source 105 first propagates inside the light guide plate 101; that is, at least a portion of the light path of the point light source 105 is in the light guide plate 101.

In the embodiment of the present disclosure, by applying the array of inverted pyramid grooves in the light guide plate, the light beam from a point light source can be reflected by the array of inverted pyramid grooves and laterally propagated inside the light guide plate. The angle and the number of reflection and diffraction are increased by the array of inverted pyramid grooves, so that most of the incident light repeatedly oscillates in the light guide plate. Therefore, a uniform backlight output can be obtained using only a thin light guide plate, and the thickness required for the light guide plate can be reduced.

In the context of the present disclosure, “point light source” means that the size of the light source is so small that the size of the light source is negligible compared to the size of the light guide plate. For example, the length/width of the point light source may be 1/100 or less of the width of the light guide plate.

In certain exemplary embodiments, as shown in FIG. 1, the backlight module 100 further includes a reflective layer 106. The reflective layer 106 includes a fitting surface 107, and the fitting surface 107 fits with the bottom surface 103. A shape of the fitting surface 107 is complementary to a shape of the bottom surface 103.

In certain exemplary embodiments, each point light source corresponds to a cone top of an inverted pyramid groove in the array of inverted pyramid grooves.

In certain exemplary embodiments, as shown in FIG. 2, each inverted pyramid groove is a quadrangular pyramid groove. For example, the quadrangular pyramid groove may have a size in the range of 200 to 800 nm.

In the embodiments of the present disclosure, an array of quadrangular pyramid grooves can be used to achieve reflection and diffraction of the light beam. By using quadrangular pyramid grooves of a nanometer size, the angle and the number of reflection and diffraction for incident light can be effectively increased, thereby further reducing the thickness of the light guide plate. Those skilled in the art can understand that it is also possible to use a groove of a shape such as a triangular pyramid, a pentagonal pyramid or a hexagonal pyramid to achieve reflection and diffraction of the light beam. In the context of the present disclosure, the term “size” refers to a length or width of an element in a plane parallel to the direction in which the light guide plate extends.

In certain exemplary embodiments, as shown in FIG. 1, in the quadrangular pyramid groove, an included angle formed by a side surface of the quadrangular pyramid groove and a bottom surface of the quadrangular pyramid groove is in a range of 40°˜70°. Each point light source has a beam angle of about 120°.

With the included angle in the range of 40°˜70°, a large reflection angle and a large diffraction angle can be obtained, thereby efficiently diffusing the light beam.

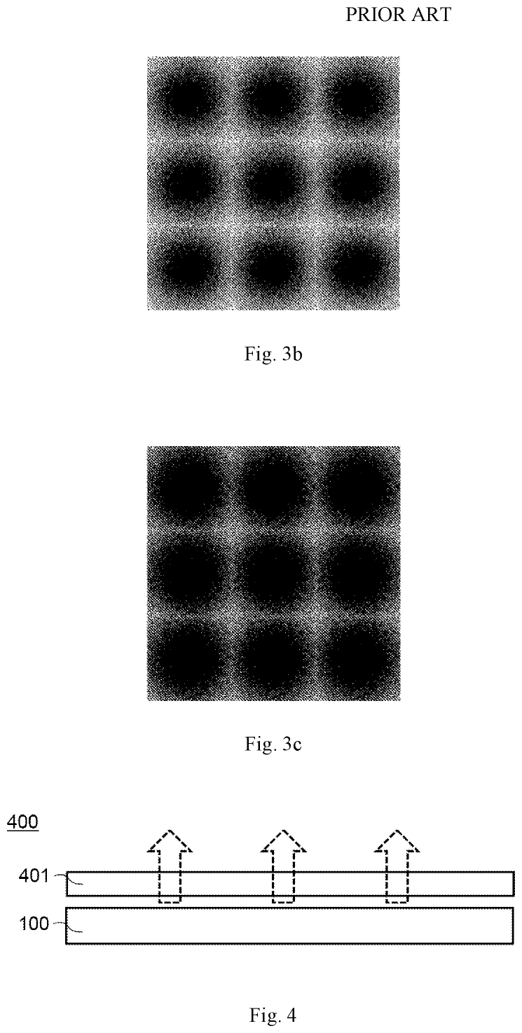

In an embodiment, as shown in FIG. 1, an included angle formed by a side surface of the quadrangular pyramid groove and a bottom surface of the quadrangular pyramid groove is 51.7°, and the repetition period of the quadrangular pyramid grooves is 250 nm. A model of this example can be built using the FDTD module of the modeling simulation software Lumerical. When the light source is collimated, the reflectivity of the light guide plate whose bottom surface is a planar structure is 84%; when the bottom surface of the light guide plate is provided with an array of quadrangular pyramid grooves, the overall reflectivity of the light guide plate is 6.3%; when the incident angle is 30°, the overall reflectivity increases to 18%; when the incidence angle is 60°, the overall reflectivity is 30%. In the context of the present disclosure, the term “incident angle” to refers to the angle between the incident beam and the normal to the plane of the light guide plate. When the incident angle is large, the incident light leaves the pyramid after undergoing multiple reflections and diffractions inside the pyramid. As shown in FIG. 3a, the light beam L having an incident angle greater than zero is reflected three times inside a quadrangular pyramid. The incident angle of the Lambertian light source is mainly between 0 and 30°, so about 6%-18% of the light is directly reflected, and the remaining 94%-82% of the light is transmitted within the light guide plate at an angle greater than the total reflection angle, and then extracted using dots (e.g., dots disposed on the light exit surface of the light guide plate) to provide a uniform light distribution pattern in the far field. FIG. 3b is a far field light distribution pattern of a conventional backlight module, and FIG. 3c is a far field light distribution pattern of a backlight module according to an embodiment of the present disclosure. It can be seen that the backlight module according to the embodiment of the present disclosure provides a more uniform light distribution pattern in the far field.

In certain exemplary embodiments, each point light source is individually controlled and the plurality of point light sources have different brightness from each other.

By individually controlling each point light source, fast response can be achieved and local dimming can be achieved with an ultra-high contrast. Those skilled in the art will understand that a transparent conductive material such as ITO can be used to form a circuit structure on the light exit surface to electrically connect the light emitting diode (or micro-light emitting diode) to the power supply circuit. The light emitting diodes (or micro-light emitting diodes) can be arranged in a matrix. Further, it is also possible to realize white light output by using a single color (for example, blue or green) light emitting diode (or micro-light emitting diode) and a suitable phosphor material.

In certain exemplary embodiments, the plurality of point light sources are light emitting diodes. For example, the point light source may be a micro-light emitting diode (Micro-LED) having a size of less than or equal to 100 μm.

In the embodiment of the present disclosure, by using a micro-light emitting diode having a size of less than or equal to 100 μm, the occlusion of the point light source on the light guide plate by the point light source itself can be further avoided. Therefore, a uniform backlight output can be obtained.

In certain exemplary embodiments, as shown in FIG. 1, the backlight module 100 further includes a plurality of dots 108 located on the light exit surface 102. The plurality of dots 102 are configured to redirect light to a direction perpendicular to the light exit surface 102.

In some embodiments, the light transmitted inside the light guide plate can be extracted from the light exit surface uniformly by using the dots disposed on the light exit surface.

In certain exemplary embodiments, as shown in FIG. 1, the backlight module 100 further includes a brightness enhancement film 109 disposed on a side of the light guide plate 101 away from the reflective layer 106.

In some embodiments, a brightness enhancement film is disposed on a side of the light guide plate away from the reflective layer, thereby further homogenizing the light beam and shielding the black spots generated by the light sources (i.e., the light emitting diodes or the micro-light emitting diodes) and the pattern of the circuit structure on the light exit surface. The brightness enhancement film may be a conventional brightness enhancement film (BEF) or a dual brightness enhancement film (DBEF).

In certain exemplary embodiments, a material of the reflective layer 106 is a reflective metal; a material of the light guide plate 101 is one of a transparent resin material and a transparent PMMA material.

The reflective layer may be made of a reflective metal, which can achieve high reflectivity, further increase the light utilization efficiency of the light source, and improve the heat dissipation performance of the backlight module. The light guide plate may also be made of a transparent resin material or a transparent PMMA material, thereby achieving higher light transmission efficiency and reducing light loss.

According to another exemplary embodiment of the present disclosure, a liquid crystal display device is provided. Referring to FIG. 4, the liquid crystal display device 400 includes a liquid crystal display panel 401 and the backlight module 100 according to any one of above-mentioned embodiments. The light exit surface of the backlight module 100 faces the light entrance surface of the liquid crystal display panel 401 to provide backlight illumination to the liquid crystal display panel 401.

The liquid crystal display device can be any product or component with display function, such as mobile phone, tablet computer, TV, display, notebook computer, digital photo frame, navigator and so on. The implementation of the liquid crystal display device can refer to the embodiments of the above-mentioned backlight module, which will not be repeated herein.

According to another exemplary embodiment of the present disclosure, an electronic apparatus is provided. The electronic apparatus includes the liquid crystal display device according to the above-mentioned embodiment.

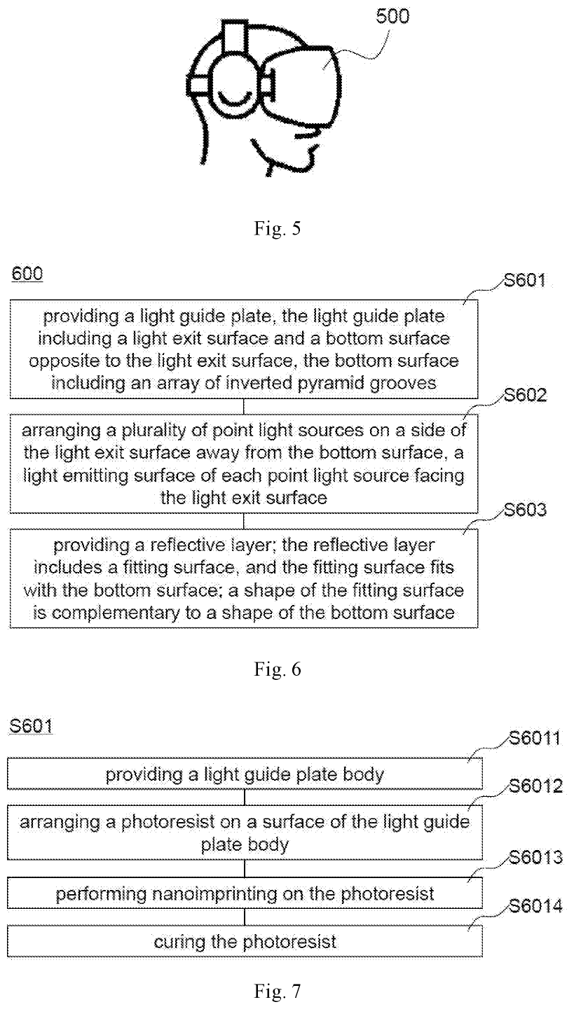

In certain exemplary embodiments, as shown in FIG. 5, the electronic apparatus 500 is a virtual reality apparatus or an augmented reality apparatus.

The electronic apparatus can be applied to virtual reality (VR), augmented reality (AR) or other high-resolution display fields, thereby further reducing the weight and volume of the virtual reality apparatus or the augmented reality apparatus.

According to yet another exemplary embodiment of the present disclosure, a method for manufacturing a backlight module is provided. As shown in FIG. 6, the method includes the following steps: S601, providing a light guide plate, the light guide plate including a light exit surface and a bottom surface opposite to the light exit surface, the bottom surface including an array of inverted pyramid grooves; and S602, arranging a plurality of point light sources on a side of the light exit surface away from the bottom surface, a light emitting surface of each point light source facing the light exit surface.

In the embodiment of the present disclosure, by applying the array of inverted pyramid grooves in the light guide plate, the light beam from a point light source can be reflected by the array of inverted pyramid grooves and laterally propagated inside the light guide plate. The angle and the number of reflection and diffraction are increased by the array of inverted pyramid grooves, so that most of the incident light repeatedly oscillates in the light guide plate. Therefore, a uniform backlight output can be obtained using only a thin light guide plate, and the thickness required for the light guide plate can be reduced.

In certain exemplary embodiments, as shown in FIG. 7, the step S601 of providing the light guide plate includes: S6011, providing a light guide plate body; S6012, arranging a photoresist on a surface of the light guide plate body; S6013, performing nanoimprinting on the photoresist; and S6014, curing the photoresist.

In certain exemplary embodiments, as shown in FIG. 6, the method 600 further includes: S603, providing a reflective layer. The reflective layer includes a fitting surface, and the fitting surface fits with the bottom surface; a shape of the fitting surface is complementary to a shape of the bottom surface.

According to the backlight module, the method for manufacturing the same, the liquid crystal display device and the electronic apparatus provided by the present disclosure, by applying the array of inverted pyramid grooves in the light guide plate, the light beam from a point light source can be reflected by the array of inverted pyramid grooves and laterally propagated inside the light guide plate. The angle and the number of reflection and diffraction are increased by the array of inverted pyramid grooves, so that most of the incident light repeatedly oscillates in the light guide plate. Therefore, a uniform backlight output can be obtained using only a thin light guide plate, and the thickness required for the light guide plate can be reduced.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A backlight module, comprising:
a light guide plate comprising a light exit surface and a bottom surface opposite to the light exit surface; the bottom surface comprising an array of inverted pyramid grooves; and
a plurality of point light sources located on a side of the light exit surface away from the bottom surface; wherein a light emitting surface of each point light source faces the light exit surface.

2. The backlight module according to claim 1, further comprising: a reflective layer;
wherein the reflective layer comprises a fitting surface, and the fitting surface fits with the bottom surface; and a shape of the fitting surface is complementary to a shape of the bottom surface.

3. The backlight module according to claim 1, wherein each point light source corresponds to a cone top of an inverted pyramid groove in the array of inverted pyramid grooves.

4. The backlight module according to claim 1, wherein each inverted pyramid groove is a quadrangular pyramid groove.

5. The backlight module according to claim 4, wherein in the quadrangular pyramid groove, an included angle formed by a side surface of the quadrangular pyramid groove and a bottom surface of the quadrangular pyramid groove is in a range of 40° to 70°.

6. The backlight module according to claim 1, wherein each point light source has a beam angle of about 120°.

7. The backlight module according to claim 1, wherein each point light source is individually controlled and the plurality of point light sources have different brightness from each other.

8. The backlight module according to claim 1, wherein the plurality of point light sources are light emitting diodes.

9. The backlight module according to claim 1, further comprising: a plurality of dots located on the light exit surface, wherein the plurality of dots are configured to redirect light to a direction perpendicular to the light exit surface.

10. The backlight module according to claim 2, further comprising: a brightness enhancement film disposed on a side of the light guide plate away from the reflective layer.

11. The backlight module according to claim 2, wherein a material of the reflective layer is a reflective metal; and a material of the light guide plate is one of a transparent resin material and a transparent PMMA material.

12. A liquid crystal display device comprising a liquid crystal display panel and the backlight module according to claim 1; wherein the backlight module is disposed on a light entrance side of the liquid crystal display panel.

13. A method for manufacturing a backlight module, comprising:
providing a light guide plate, the light guide plate comprising a light exit surface and a bottom surface opposite to the light exit surface, the bottom surface comprising an array of inverted pyramid grooves; and
arranging a plurality of point light sources on a side of the light exit surface away from the bottom surface, a light emitting surface of each point light source facing the light exit surface.

14. The method according to claim 13, wherein providing the light guide plate comprises:
providing a light guide plate body;
arranging a photoresist on a surface of the light guide plate body;
performing nanoimprinting on the photoresist; and
curing the photoresist.

15. The method according to claim 13, further comprising: providing a reflective layer;
wherein the reflective layer comprises a fitting surface, and the fitting surface fits with the bottom surface; and a shape of the fitting surface is complementary to a shape of the bottom surface.

16. The liquid crystal display device according to claim 12, further comprising: a reflective layer;
wherein the reflective layer comprises a fitting surface, and the fitting surface fits with the bottom surface; and a shape of the fitting surface is complementary to a shape of the bottom surface.

17. The liquid crystal display device according to claim 12, wherein each point light source corresponds to a cone top of an inverted pyramid groove in the array of inverted pyramid grooves.

18. The liquid crystal display device according to claim 12, wherein each inverted pyramid groove is a quadrangular pyramid groove.

19. The liquid crystal display device according to claim 18, wherein in the quadrangular pyramid groove, an included angle formed by a side surface of the quadrangular pyramid groove and a bottom surface of the quadrangular pyramid groove is in a range of 40°˜70°.

20. An electronic apparatus comprising the liquid crystal display device according to claim 12.
